(19) United States
(12) Patent Application Publication
(10) Pub. No.: US 2009/0213325 A1
(43) Pub. Date: Aug. 27, 2009

(54) Step zone progressive lens

(76) Inventors: Dan Katzman, Givat Ela (IL); Gabby Weinrot, Upper Galilee (IL)

Correspondence Address: Pearl Cohen Zedek Latzer, LLP, 1500 Broadway, 12th Floor, New York, NY, 10036, US

(21) Appl. No.: 12/071,641

(22) Filed: Feb. 25, 2008

(51) Int. Cl. G02C 7/06; G02B 3/10

(52) U.S. Cl. 351/169; 359/653; 351/177

(57) ABSTRACT

The present invention provides a progressive lens comprising at least one area with gradually increasing optical power, the area having a first region where the gradient of the optical power decreases towards a second region with reduced gradient of optical power, and a third region following the second region where the gradient of the optical power increases. The present invention further provides a method for producing progressive lens, the method comprising computing location on the lens on which a second region with reduced gradient of optical power should be produced and a required optical power in the second region; producing based on the computations an area on the lens with gradually increasing optical power, the area having a first region where the gradient of the optical power decreases towards the second region, and a third region following the second region where the gradient of the optical power increases.

### BACKGROUND OF THE INVENTION

Progressive lenses may be used, for example, in eyeglasses or contact lens to correct optical defects in the eye, for example, presbyopia. They are characterized by a gradient of increasing lens optical power, optionally added to the wearer's correction for the other refractive errors of the eye. The optical power of progressive lens may gradually change particularly in an intermediate vision zone located between the optical center of the lens and the lower part of it. The gradient may start at a small, or no optical power addition, at the top of the lens and may reach a larger optical power addition at the bottom of the lens. The addition value prescribed depends on the level of the optical defect in the eye, for example, presbyopia, of the patient.

A disadvantage of progressive lenses is that the power progression along the vertical main axes of the lens creates regions of astigmatism on both sides of the main gradient path along which the optical power changes, especially in the intermediate zone. The level of astigmatism in these regions may be higher as the gradient of the optical power addition is greater. FIG. 1 illustrates astigmatism created on a progressive lens 100. The astigmatism map illustrated in FIG. 1 maps the astigmatism on the field of view of the viewer, and therefore the map is divided by horizontal and vertical lines representing angles from the center of the field of view, which in principle should be substantially coincident with the optical center of the lens. Darker regions of the map represent regions with greater astigmatism. Regions 120 and 130 represent regions of the lens of substantially constant or very lightly changing optical power. Therefore, these regions may suffer of almost no astigmatism. Region 120 may have, for example, weaker optical power then region 130. The optical power may gradually increase in an intermediate zone 110 between regions 120 and 130, for example, from the optical center of lens 100 to approximately 30 degrees below the center. The gradient of optical power may produce regions 110a and 110b of severe astigmatism, e.g. more than 1 diopter, for example, within the dashed lines, for example, on both sides of intermediate zone 110. Regions 110a and 110b may create a very narrow channel with no significant astigmatism, e.g., astigmatism below 1 diopter. The width of this channel along horizontal line 112, for example, at about 18 degrees below the optical center of lens 100 may be of about, for example, 12 horizontal degrees. Regions of astigmatism 110a and 110b may result from the strictly increasing optical power gradient through intermediate zone 110.

The intermediate zone along which the optical power changes is usually called the progressive channel of the lens, since regions of astigmatism 110a and 110b may leave a narrow channel at zone 110 with no significant astigmatism. In some situations, the user of the lens may have to look through progressive channel 110, for example, when looking at a computer screen, for example, when sitting in front of it. In such situation, the user may not view the computer screen sharply and clearly to its full width.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of astigmatism map of a regular progressive lens;

FIGS. 2A and 2B are graph illustrations of optical power changes along the main gradient path from the top of the lens to the bottom of the lens, in a regular progressive lens and in a progressive lens according to some embodiments of the present invention, respectively;

FIG. 2C is a graph illustration of optical power addition changes along a main gradient path from the top of the lens to the bottom of the lens, having two regions with lower gradient of optical power in the progressive channel of the lens according to some embodiments of the present invention;

FIG. 3 is an example of optical power addition map of a regular progressive lens;

FIG. 4 is a schematic example of an optical power addition map of a progressive lens according to some embodiments of the present invention;

FIG. 5 is an example of an astigmatism map of a progressive lens according to some embodiments of the present invention; and

FIG. 6 is a flowchart illustrating a method for producing progressive lens according to embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention may provide progressive lens with a region with substantially lower gradient within the gradient of optical power, or, for example, a constant optical power region within the progressive channel of the lens according to some embodiments of the present invention. The astigmatism at the sides of the lower gradient or constant optical power region may be lower than in regions with large gradient of optical power. The progressive lens according to embodiments of the present invention may provide a wide field of view through the lower gradient region, thus, for example, a user may comfortably watch through the lower gradient of optical power region, for example, a computer screen or other object requiring a very lightly varying optical power or a substantially constant optical power and located against the progressive channel in the field of view.

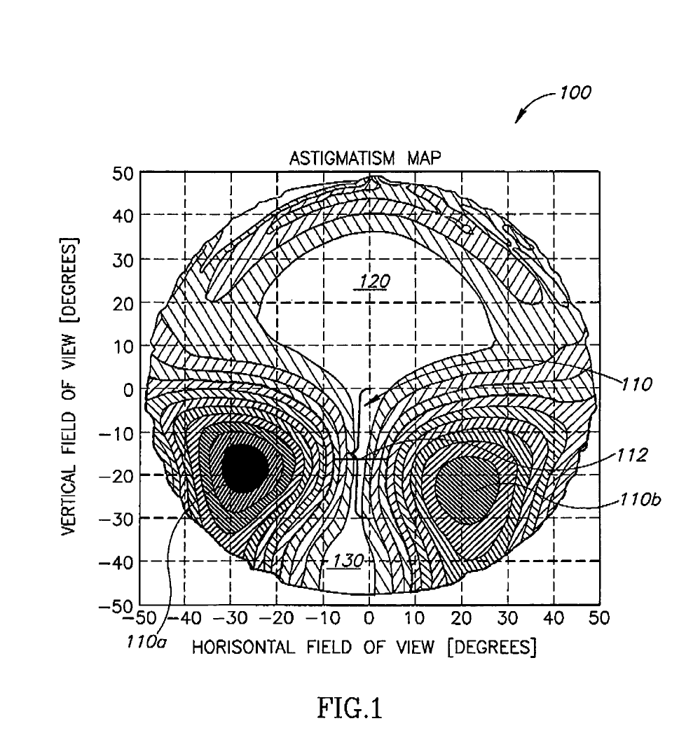

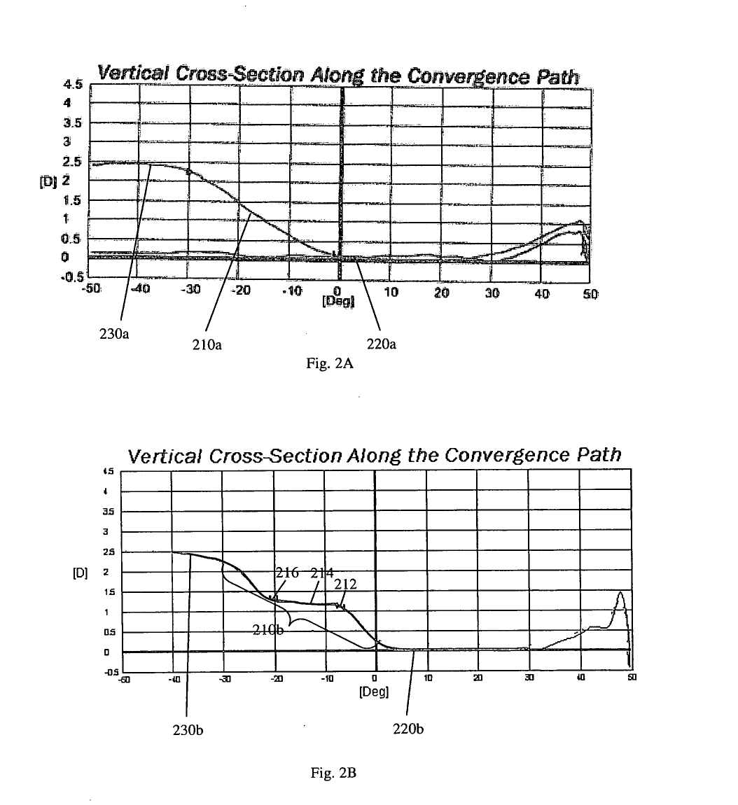

Reference is now made to FIGS. 2A and 2B which are graph illustrations of optical power addition changes along the main gradient path from the top of the lens to the bottom of the lens. FIG. 2A illustrates the gradient of optical power in a regular progressive lens. The optical power may gradually increase along gradient region 210a (corresponding, for example, to 110 in FIG. 1) from a small or substantially zero optical power addition at region 220a (corresponding, for example, to region 120 in FIG. 1) to a larger optical power in region 230a (corresponding, for example, to region 130 in FIG. 1). The optical power gradient in region 210a may be a strictly increasing function from region 220a to region 230a. This optical power gradient may produce severe regions of astigmatism on both sides of the intermediate zone 110, leaving a very narrow channel without astigmatism.

FIG. 2B illustrates the gradient of optical power in a progressive lens having a region with lower gradient of optical power in the progressive channel of the lens according to some embodiments of the present invention. In FIG. 2B the optical power may gradually increase along gradient region 210b from a small or substantially zero optical power addition at region 220b to a larger optical power in region 230b, for example, from approximately the optical center of the lens to about 30 degrees below the center. Gradient region 210b may include a moderation region 212 where the gradient of the optical power may decrease towards a region 214 with lower gradient of optical power than in the rest of region 210b or, for example, constant optical power. Region 214 may be located, for example, approximately in the middle of region 210b, from about, for example, 7 degrees below the optical center of the lens to about 20 degrees below the optical center. Gradient region 210b may further include an immoderation region 216 following region 214 where the gradient of the optical power may increase. Thus, for example, a region with lower gradient of optical power or a substantially constant optical power within the progressive channel of the lens may be created, effecting reduced astigmatism on sides of the corresponding region of the progressive channel.

Reference is now made to FIG. 2C, which is a graph illustration of optical power addition changes along a main gradient path from the top of the lens to the bottom of the lens, having two regions with lower gradient of optical power in the progressive channel of the lens according to some embodiments of the present invention. In FIG. 2C the optical power may gradually increase along gradient region 210c from a small or substantially zero optical power addition at region 220c to a larger optical power in region 230c, for example, from approximately the optical center of the lens to about 40 degrees below the center. Gradient region 210c may include a moderation region 222c where the gradient of the optical power may decrease towards a region 224c with lower gradient of optical power or, for example, constant optical power. Gradient region 210c may further include an immoderation region 226c following region 224c where the gradient of the optical power may increase towards a region 218c with higher gradient of optical power. Thus, for example, a region with lower gradient of optical power or a substantially constant optical power within the progressive channel of the lens may be created, effecting reduced astigmatism on a region corresponding to region 224c on the sides of the progressive channel. Additionally, gradient region 210c may include an additional moderation region 212c, for example, following region 218c, where the gradient of the optical power may decrease towards a region 214c with lower gradient of optical power or, for example, constant optical power. Gradient region 210c may further include an additional immoderation region 216c following region 214c where the gradient of the optical power may increase. Thus, for example, an additional region with lower gradient of optical power or a substantially constant optical power within the progressive channel of the lens may be created, effecting reduced astigmatism on a region corresponding to region 214c on the sides of the progressive channel. It will be appreciated that although in the example of FIG. 2C gradient region 210c may include two regions with lower optical power, 214c and 224c, the gradient region of a lens according to embodiments of the present invention may include any other suitable number of regions with lower optical power, as may be required and/or may be enabled in each case.

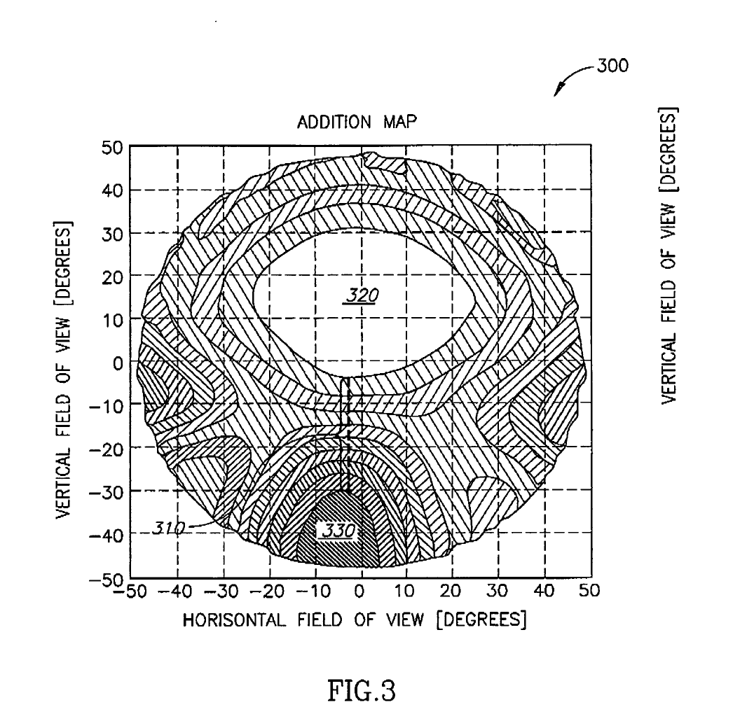

Reference is now made to FIG. 3, which is an example of optical power addition map of a regular progressive lens 300. Lens 300 may be similar to lens 100 of FIG. 1. Darker regions represent regions of greater optical power. Progressive lens 300 may include regions 320 and 330. Region 320 may have a weaker optical power than region 330. The optical power of lens 300 may increase gradually along main gradient path 310 from region 320 to region 330, for example, substantially from the optical center of lens 300 to approximately 30 degrees below the center, which may correspond, for example, to region 210a of FIG. 2a. The optical power addition at region 320 may be very small or, for example, of approximately zero diopters. The optical power addition at region 330 may have, for example, nominal value of approximately 2.25 diopters.

The optical power gradient along gradient path 310 may be a strictly increasing function. This optical power gradient may produce severe regions of astigmatism on both sides of gradient path 310, leaving a very narrow channel with no significant astigmatism.

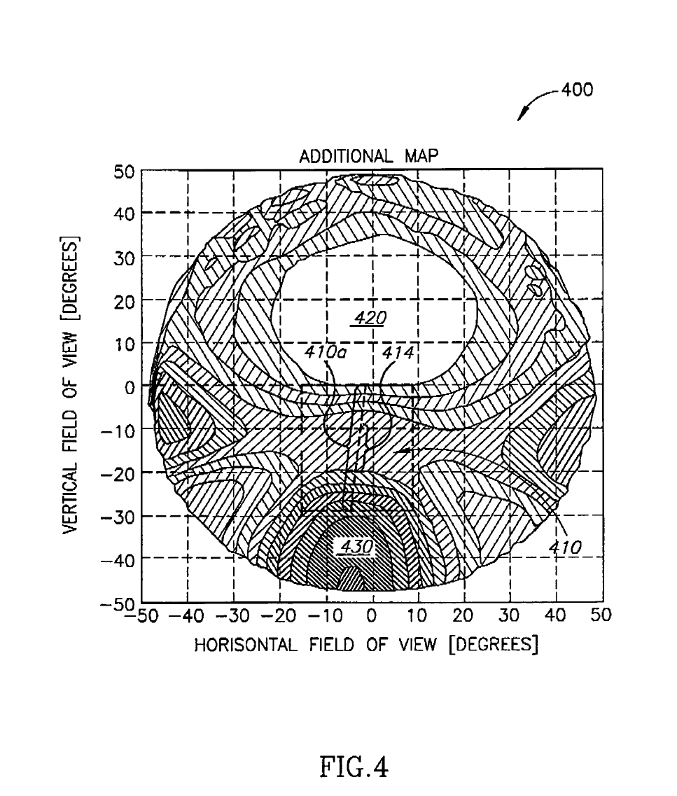

Reference is now made to FIG. 4, which is a schematic example of an optical power addition map of a progressive lens 400 according to some embodiments of the present invention. Darker regions represent regions of greater optical power. Progressive lens 400 may include regions 420 and 430. Region 420 may have a weaker optical power than region 430. The optical power of lens 400 may increase gradually along main gradient path 410a through intermediate region 410 from region 420 to region 430, for example, substantially from the optical center of lens 400 to approximately 30 degrees below the center, which may correspond, for example, to region 210b of FIG. 2b. Within this region, lens 400 may include region 414 of lower gradient of optical power than the rest of region 410 or, for example, constant optical power, which may correspond, for example, to region 214 of FIG. 2b. Astigmatism regions may occur on the sides of line 410, which may be severe as the gradient along line 410 is greater. Region 414 of lower gradient of optical power may enable reduced astigmatism on the sides of region 414 and/or widened region of low gradient of optical power, which may allow widened field of view through region 414. Region 414 of lower gradient of optical power may be located, for example, approximately in the middle of region 410, from about, for example, 7 degrees below the optical center of the lens to about 20 degrees below the optical center.

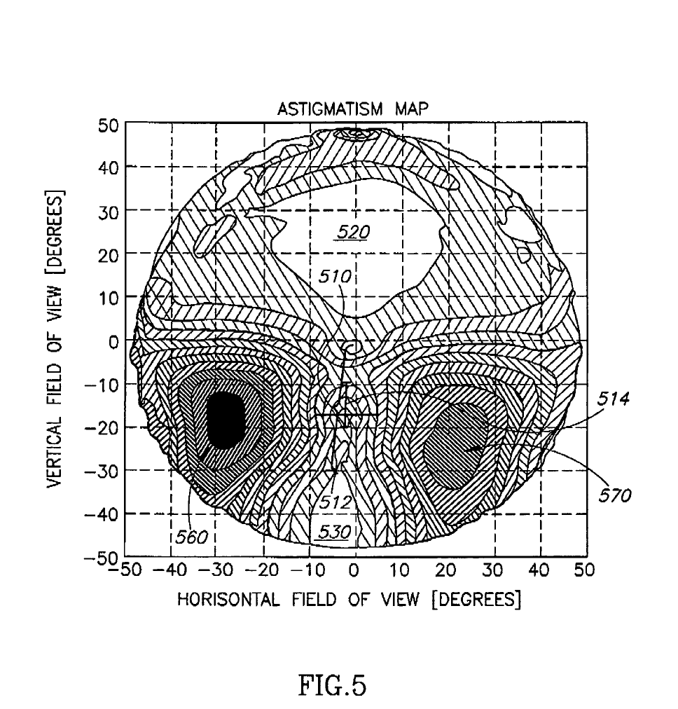

Reference is now made to FIG. 5, which is an example of an astigmatism map of a progressive lens 500 according to some embodiments of the present invention. Lens 500 may be similar to lens 400 of FIG. 4. Darker regions represent regions of greater astigmatism. Progressive lens 500 may include regions 520 and 530. Regions 520 and 530 represent regions of the lens of substantially constant or very lightly changing optical power. Therefore, these regions may suffer of almost no astigmatism. Region 520 may have, for example, weaker optical power then region 530. The optical power may gradually increase in an intermediate zone 510 between regions 520 and 530, for example, from the optical center of lens 500 to approximately 30 degrees below the center.

The gradient of optical power may result in regions of astigmatism 560 and 570, for example, of above 1 diopter, on both sides of the intermediate zone 510. Lens 500 may include segment 514 of widened field of view with no significant astigmatism, corresponding to a region with reduced gradient of optical power or, for example, constant optical power, for example, similar to segment 414 of lens 400. Segment 514 may extend, for example, from about, for example, 7 degrees below the optical center of the lens to about 20 degrees below the optical center the of lens 500, thus, for example, effecting reduced astigmatism on sides of the corresponding region of intermediate zone 510. Segment 514 of widened field of view with no significant astigmatism, e.g., astigmatism below 1 diopter, may have width along horizontal line 512, for example, at a similar vertical location as line 112 of FIG. 1. The width along line 512 may be wider by about 10% or more than the width along line 112 of at a corresponding vertical location on lens 100. Therefore a wider field of view may be provided when looking through region 514 then through a corresponding region on lens 100.

According to some embodiments of the present invention, changes in optical power of the lens may be produced on the back side of the lens, for example, on a standard semi-finished lens with standard front curve, for example, spherical curve. The production on the back side may be controlled, for example, by a computer, which may compute, for example, personalized characteristics of the lens specific for needs and preferences of a user. The characteristics may include, for example, location on the lens and/or the optical power of regions 214 and/or 414 and/or 514 described above with reference to FIGS. 2b, 4 and 5 respectively. The characteristics may be determined, for example, based on the distance of the computer screen from the user's eye.

According to some embodiments of the present invention, regions 214 and/or 414 and/or 514 described above may be at a location on the lens suitable for viewing a computer screen when sitting in front of it. It would be apparent that location of regions 214 and/or 414 and/or 514 described above may be set to accommodate decreased astigmatism when viewing other mid-range located objects.

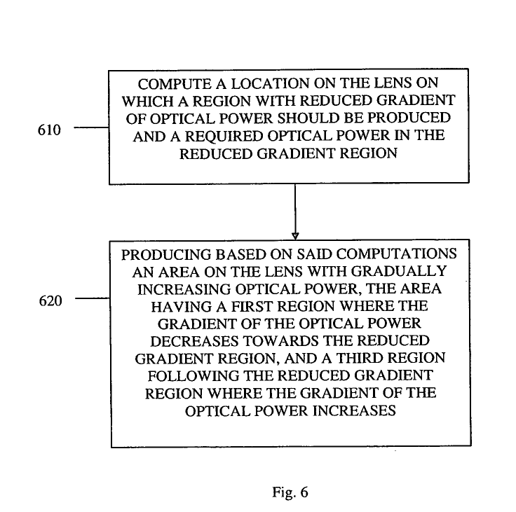

Reference is now made to FIG. 6, which is a flowchart illustrating a method for producing progressive lens according to embodiments of the present invention. As indicated in block 610, the method may include computing location on the lens on which a region with reduced gradient of optical power or, for example, a substantially constant optical power should be produced and a required optical power in this region. The reduced gradient region may be similar, for example to regions 214 and/or 414 and/or 514 described above with reference to FIGS. 2b, 4 and 5. The location of the reduced gradient region on the lens may be suitable for viewing, for example, a computer screen when sitting in front of it or other object requiring a very lightly varying optical power or a substantially constant optical power and located against the progressive channel in the field of view. As indicated in block 620, the method may include producing based on the computations an area on the lens with gradually increasing optical power, for example, region 210b of FIG. 2B, the area having a first region, for example, region 212 of FIG. 2B, where the gradient of the optical power decreases towards the reduced gradient region, for example, region 214 of FIG. 2B, and a third region, for example, region 216 of FIG. 2B, following the reduced gradient region where the gradient of the optical power increases. The production may be performed, for example, on the back side of the lens as described above.

It will be appreciated that the production of the changing gradient of optical power according to embodiments of the present invention as described for example, with reference to FIGS. 2b, 4, 5 and 6, is not limited to production on the back side of the lens and may be produced on the back side, front side and/or on both sides of the lens as may be required and/or preferred.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A progressive lens comprising:
at least one area with gradually increasing optical power, said area having a first region where the gradient of the optical power decreases towards a second region with reduced gradient of optical power, and a third region following the second region where the gradient of the optical power increases.

2. The progressive lens according to claim 1, wherein said second region includes substantially constant optical power.

3. The progressive lens according to claim 1, wherein changes in optical power of the lens are produced on the back side of the lens.

4. The progressive lens according to claim 1, wherein changes in optical power of the lens are produced on the front side of the lens.

5. The progressive lens according to claim 1, wherein changes in optical power of the lens are produced on both sides of the lens.

6. The progressive lens according to claim 1, wherein said second region is in a region of the lens suitable for viewing a computer screen when sitting in front of it.

7. The progressive lens according to claim 1, wherein changes in optical power of the lens are produced to adjust characteristics of said second region to the preferences and eye quality of the user of said lens, the characteristics are at least one from a list comprising location on the lens and the optical power of said second region.

8. The progressive lens according to claim 1, wherein said at least one area includes at least two areas with gradually increasing optical power, each of said areas having a first region where the gradient of the optical power decreases towards a second region with reduced gradient of optical power, and a third region following the second region where the gradient of the optical power increases.

9. A method for producing progressive lens, the method comprising:
computing location on the lens on which a second region with reduced gradient of optical power should be produced and a required optical power in said second region;
producing based on said computations at least one area on the lens with gradually increasing optical power, said area having a first region where the gradient of the optical power decreases towards said second region, and a third region following the second region where the gradient of the optical power increases.

10. A method according to claim 9, wherein said second region includes substantially constant optical power.

11. A method according to claim 9, wherein said producing comprising production of changes in optical power of the lens on the back side of the lens.

12. A method according to claim 9, wherein said producing comprising production of changes in optical power of the lens on the front side of the lens.

13. A method according to claim 9, wherein said producing comprising production of changes in optical power of the lens on both sides of the lens.

14. A method according to claim 9, wherein said computing comprising computation of location of said second region which is in a region of the lens suitable for viewing a computer screen when sitting in front of it.

15. A method according to claim 9, wherein said producing comprising production of changes in optical power of the lens to adjust characteristics of said second region to the preferences and eye quality of the user of said lens, the characteristics from a list comprising location on the lens and the optical power of said second region.

16. A method according to claim 9, wherein said at least one area includes at least two areas with gradually increasing optical power, each of said areas having a first region where the gradient of the optical power decreases towards a second region with reduced gradient of optical power, and a third region following the second region where the gradient of the optical power increases.
